(19) United States
(12) Patent Application Publication
(10) Pub. No.: US 2025/0053736 A1
(43) Pub. Date: Feb. 13, 2025

(54) Method and apparatus for generating text corpus by using knowledge graph

(71) Applicant: Alipay (Hangzhou) Information Technology Co., Ltd., Hangzhou (CN)

(72) Inventors: Deng ZHAO, Hangzhou (CN); Bin HU, Hangzhou (CN); Lei SHI, Hangzhou (CN); Jianshan HE, Hangzhou (CN)

(21) Appl. No.: 18/776,711

(22) Filed: Jul. 18, 2024

(30) Foreign Application Priority Data
Jul. 21, 2023 (CN) 202310906808.5

(51) Int. Cl. G06F 40/20; G06F 16/36

(52) U.S. Cl. CPC G06F 40/20; G06F 16/367

(57) ABSTRACT

Embodiments of this specification provide a method and an apparatus for generating a text corpus by using a knowledge graph. Graph elements of the knowledge graph include a node representing an entity and a connecting edge representing a relationship between nodes. Privacy data can be organized into structured data by using the knowledge graph. The graph data includes several triplets including graph elements in the subgraph, and the ontology information includes at least a type of each graph element in the subgraph. Several sentences are generated based on several pre-constructed sentence templates, the graph data, and the ontology information. The several sentences are classified into a generated sentence set, and at least one of the several sentence templates is constructed based on the ontology information. A text corpus corresponding to the subgraph is determined based on the generated sentence set. The text corpus is used to train a language model.

### TECHNICAL FIELD

One or more embodiments of this specification relate to the field of computer technologies, and in particular, to a method and an apparatus for generating a text corpus by using a knowledge graph.

### BACKGROUND

A language model is a natural language processing model trained based on a deep learning technology and a large-scale corpus. A main function of the language model is to predict a next word, a next character, etc. in a text. By learning of a large quantity of language samples, the language model can learn of a structure and a law of a language, and can generate a proper natural language text. When a language material including privacy data is used as a training corpus, privacy preservation further needs to be performed on the training corpus. Currently, the language model is widely applied to fields such as machine translation, text generation, emotion analysis, and speech recognition, and is one of the important technologies in natural language processing. Currently, quality of the language model needs to be improved, and quality of a corpus directly affects quality of the language model.

Therefore, it is expected that an improved solution can provide a training corpus with higher quality and stronger logic.

### SUMMARY

One or more embodiments of this specification describe a method and an apparatus for generating a text corpus by using a knowledge graph, to provide a training corpus with higher quality and stronger logic. Specific technical solutions are as follows:

According to a first aspect, an embodiment provides a method for generating a text corpus by using a knowledge graph. Graph elements of the knowledge graph include a node representing an entity and a connecting edge representing a relationship between nodes, and the method includes:
reading graph data and ontology information of a subgraph in the knowledge graph, where the graph data includes several triplets including graph elements in the subgraph, and the ontology information includes at least a type of each graph element in the subgraph;
generating several sentences based on several pre-constructed sentence templates, the graph data, and the ontology information, where the several sentences are classified into a generated sentence set, and at least one of the several sentence templates is constructed based on the ontology information; and
determining a text corpus corresponding to the subgraph based on the generated sentence set, where the text corpus is used to train a language model.

In an implementation, any triplet in the several triplets includes a head node, a connecting edge, and a tail node, and the step of generating several sentences includes:
generating several sentences corresponding to the any triplet based on the several pre-constructed sentence templates.

In an implementation, the several sentence templates include a first-type template, the several sentences include a first sentence, and for the first sentence, a name of the head node is used as a subject, a relationship type corresponding to the connecting edge is used as a verb, and a name of the tail node is used as an object.

In an implementation, the several sentence templates include a second-type template, the several sentences include a second sentence, and for the second sentence, a type of the head node is used as a subject, a relationship type corresponding to the connecting edge is used as a verb, and a type of the tail node is used as an object.

In an implementation, the step of generating several sentences includes:
extracting node information of a target node from the graph data and the ontology information, where the node information includes a node name and a node type; and
generating several sentences corresponding to the target node based on the several pre-constructed sentence templates and the node information.

In an implementation, the several sentence templates include a third-type template, the several sentences include a third sentence, and for the third sentence, the node type is used as a subject, a preset word representing an inclusive relationship is used as a verb, and the node name is used as an object.

In an implementation, the method further includes:
obtaining several logical reasoning rules determined from the knowledge graph, where the logical reasoning rule includes the ontology information of the knowledge graph;
matching the graph data and the ontology information with each of the several logical reasoning rules, to obtain a matching rule; and
combining the graph data with the matching rule, to generate a corresponding sentence, where the sentence is classified into the generated sentence set.

In an implementation, any logical reasoning rule includes a logical condition and a reasoning result;
the step of matching the graph data and the ontology information with each of the several logical reasoning rules includes:
matching the graph data and the ontology information with a logical condition of each of the several logical reasoning rules; and
the step of generating a corresponding sentence includes:
combining node information in the graph data with a reasoning result of the matching rule.

In an implementation, a confidence of the matching rule is a first confidence; and the step of generating a corresponding sentence includes:
determining a first probability descriptor corresponding to the first confidence from a preset correspondence between a confidence and a probability descriptor; and
combining the graph data with the matching rule, and adding the first probability descriptor to the generated sentence.

In an implementation, the step of determining a text corpus corresponding to the subgraph includes:
combining a plurality of sentences in the generated sentence set, and using a sentence obtained through combination as the text corpus corresponding to the subgraph.

In an implementation, the step of combining a plurality of sentences in the generated sentence set includes:
deduplicating the plurality of sentences in the generated sentence set, and combining the duplicate-free generated sentence set.

In an implementation, the step of combining a plurality of sentences in the generated sentence set includes:
selecting to-be-combined sentences from the generated sentence set, and combining the to-be-combined sentences, where the to-be-combined sentences include sentences with the same subject and verb and sentences with the same verb and object.

According to a second aspect, an embodiment provides an apparatus for generating a text corpus by using a knowledge graph. Graph elements of the knowledge graph include a node representing an entity and a connecting edge representing a relationship between nodes, and the apparatus includes:
a reading module, configured to read graph data and ontology information of a subgraph in the knowledge graph, where the graph data includes several triplets including graph elements in the subgraph, and the ontology information includes at least a type of each graph element in the subgraph;
a generation module, configured to generate several sentences based on several pre-constructed sentence templates, the graph data, and the ontology information, where the several sentences are classified into a generated sentence set, and at least one of the several sentence templates is constructed based on the ontology information; and
a determining module, configured to determine a text corpus corresponding to the subgraph based on the generated sentence set, where the text corpus is used to train a language model.

According to a third aspect, an embodiment provides a computer-readable storage medium. The computer-readable storage medium stores a computer program, and when the computer program is executed in a computer, the computer is enabled to perform the method in any implementation of the first aspect.

According to a fourth aspect, an embodiment provides a computing device, including a memory and a processor. The memory stores executable code, and when the processor executes the executable code, the method in any implementation of the first aspect is implemented.

According to the method and the apparatus provided in the embodiments of this specification, the graph data and the ontology information of the subgraph correspond to ontology information in a sentence template, to construct a sentence based on the graph data and the ontology information of the subgraph. In the method, rich and logical knowledge data in the knowledge graph can be converted into texts, and the texts are used as a training corpus, to obtain a training corpus with higher quality and stronger logic.

### BRIEF DESCRIPTION OF DRAWINGS

To describe the technical solutions of the embodiments of this application more clearly, the following briefly describes the accompanying drawings required for describing the embodiments. Clearly, the accompanying drawings in the following descriptions show merely some embodiments of this application, and a person of ordinary skill in the art can still derive other drawings from these accompanying drawings without creative efforts.

FIG. 1 is a schematic diagram of an implementation scenario of an embodiment disclosed in this specification;

FIG. 2 is a schematic flowchart of a method for generating a text corpus by using on a knowledge graph according to an embodiment; and

FIG. 3 is a schematic block diagram of an apparatus for generating a text corpus by using a knowledge graph according to an embodiment.

### DESCRIPTION OF EMBODIMENTS

The following describes the solutions provided in this specification with reference to the accompanying drawings.

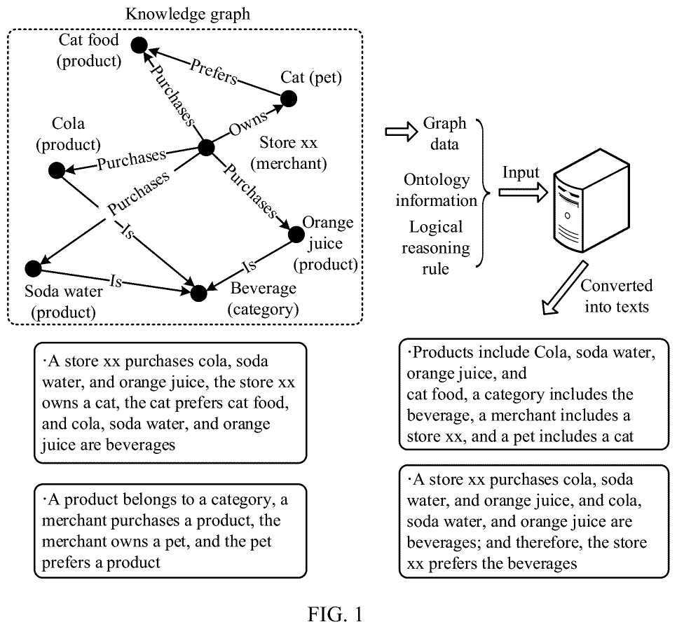

FIG. 1 is a schematic diagram of an implementation scenario of an embodiment disclosed in this specification. Graph data and ontology information of a subgraph are extracted from a knowledge graph, and are input into a computing device. The computing device can convert graphic data and ontology information into a text based on a correspondence between graphic data and ontology information and sentence generation logic defined in a sentence template. There can be a plurality of sentence templates. For the graph data of the subgraph, different texts can be generated based on different sentence templates, to extract different levels of texts in the subgraph. The computing device can alternatively convert the graph data into a text based on a logical reasoning rule. A text obtained after the computing device processes the text obtained through conversion can be used as a text corpus, to train a language model.

The knowledge graph aims to describe various entities that exist in the real world or concepts of the entities and a relationship between the entities. The knowledge graph forms a huge semantic network graph, and is a knowledge base for expressing knowledge. The knowledge graph can express large and complex knowledge in a more orderly manner. Data in the knowledge graph can be extracted from a plurality of data sources such as a service platform, and constructed based on a rigorous logical relationship. Usually, the data is characterized by high factual accuracy, controllability, interpretability, etc. The knowledge graph can be applied to a plurality of fields, for example, can be applied to a semantic-based search field, applied to a recommendation field, or applied to a field of generating a user profile. When the data in the knowledge graph is constructed based on privacy data, privacy preservation needs to be performed on the data in the knowledge graph. It should be emphatically noted that all information or data mentioned in the embodiments of this specification is used when a corresponding data object grants authorization.

The knowledge graph includes a plurality of nodes and connecting edges between the nodes. The node represents an entity. Therefore, the node may also be referred to as an entity node. The connecting edge between nodes is used to represent a relationship between entity nodes. The entity is a thing in the real world, for example, a person, a place name, a concept, medicine, a company, an organization, an institution, a device, a number, a date, a currency, or an address, which are countless. The entity can be represented by an entity word, and the entity word has a noun property. For example, cola and a beverage are entities. A relationship is used to express a certain connection between different entities. For example, in a connection relationship “Cola-is-a beverage”, a relationship is “is”, and represents relationship data such as “Cola is a beverage”.

When the knowledge graph is created, an ontology (Schema) of the knowledge graph can be predefined. The ontology of the knowledge graph is a formal representation method used to describe and organize domain knowledge. The ontology information includes information used to define concepts and rules between entities, attributes, and relationships, and is used to construct and maintain the knowledge graph. Usually, the ontology information can further include an entity concept including a group of terms and definitions, to help a computer understand the domain knowledge and enable the computer to be better applied to fields such as natural language processing, information retrieval, and intelligent recommendation. The ontology information includes an entity type of the entity and a relationship type that represents a relationship between entities, namely, an entity type of a node and a relationship type of a connecting edge. The entity type can also be represented by a node type of a node. The ontology information can include a plurality of entity types and a plurality of relationship types. The ontology information can be stored in the knowledge graph, or can exist separately in a form of an ontology relationship diagram coupled to the knowledge graph. The knowledge graph defines a relationship between entities by using ontologies, so that complex knowledge in the knowledge graph has stronger logic.

In the knowledge graph shown in FIG. 1, a black dot represents a node, and an arrow line between nodes represents a relationship between nodes. A node name and a node type are noted beside a node, and a relationship type is noted on the arrow line. For example, cat food is a node name, a product is a node type or an entity type of the node, and “prefers” is a relationship type. A relationship diagram on the left side in FIG. 1 can be understood as a subgraph in which a store xx is used as a central node in the knowledge graph. A text extracted by the computing device from the subgraph is displayed in a box in a lower right part in FIG. 1.

The text corpus can also be referred to as a training corpus, and is a text dataset used to train a natural language processing model. The text corpus includes a large quantity of language samples, and can be used to train a machine learning algorithm and a deep learning model, to improve an effect of natural language processing. Quality and a quantity of training corpora have important impact on performance and an effect of a machine learning model.

The language model can be a natural language processing model, or can be a large language model. The language model is a natural language processing model trained based on a deep learning technology and a large-scale corpus. A main function of the language model is to predict a next word, a next character, etc. in a text. By learning of a large quantity of language samples, the language model can learn of a structure and a law of a language, and can generate a proper natural language text. Currently, the language model is widely applied to fields such as machine translation, text generation, emotion analysis, and speech recognition, and is one of the important technologies in natural language processing.

An embodiment of this specification provides a text corpus generation method, to obtain a training corpus with higher quality and stronger logic. In the method, graph data and ontology information of a subgraph in a knowledge graph are read. The graph data includes several triplets including graph elements in the subgraph, and the ontology information includes at least a type of each graph element in the subgraph. Then, several sentences are generated based on several pre-constructed sentence templates, the graph data, and the ontology information. The several sentences are classified into a generated sentence set, and at least one of the several sentence templates is constructed based on the ontology information. A text corpus corresponding to the subgraph can be determined based on the generated sentence set.

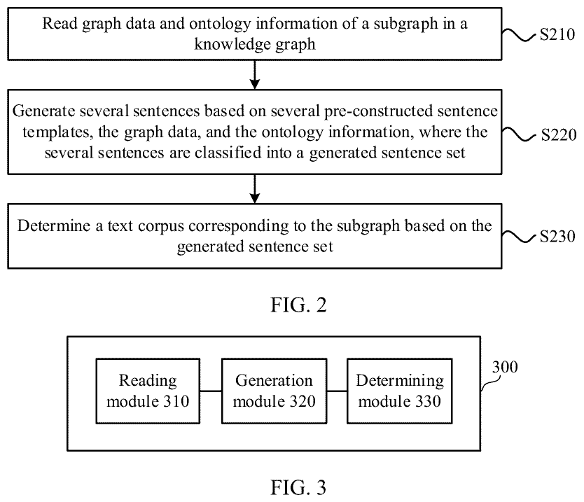

The knowledge graph includes large and complex knowledge with strong logic. This part of knowledge is fully extracted and converted into a text, and therefore, is used as a training corpus, to significantly improve quality of the training corpus. After a language model is trained based on such a training corpus, accuracy of performing text prediction by using the language model can be improved. The following describes the embodiments in detail with reference to FIG. 2.

FIG. 2 is a schematic flowchart of a method for generating a text corpus by using a knowledge graph according to an embodiment. Graph elements of the knowledge graph include a node representing an entity and a connecting edge representing a relationship between nodes. The method can be performed by a computing device, and the computing device can be implemented by using any apparatus, device, platform, device cluster, etc. that has a computing and processing capability. The computing device can be a device on a service platform. The method includes the following steps.

In step S210, graph data D1 and ontology information B1 of a subgraph K1 in the knowledge graph are read.

Data in the knowledge graph can be stored in a file, and the file is stored in the computing device or a storage device. The computing device can read graph data of a subgraph in the knowledge graph and ontology information of the subgraph from the file. The subgraph is a relationship diagram including a central node and several hops of neighboring nodes of the central node, where a node is used as the central node. Several hops include one hop, two hops, or more hops. The subgraph K1 can be any subgraph in the knowledge graph. For example, a subgraph on the left side in FIG. 1 includes two hops of neighboring nodes whose central node is a store xx. When there are too many neighboring nodes in the subgraph, the neighboring nodes can be sampled.

The ontology information B1 obtained in this step is ontology information of the subgraph K1. The graph data D1 obtained in this step includes several triplets including graph elements in the subgraph. To be specific, the triplet includes a head node, a connecting edge, and a tail node that are connected to each other. The ontology information includes at least a type of each graph element in the subgraph, for example, includes a type of the head node, a relationship type of the connecting edge, and a type of the tail node. Both the type of the head node and the type of the tail node are node types or entity types.

When the ontology information B1 of the subgraph K1 is read, the ontology information B1 can be directly read from the subgraph K1, or can be read from an ontology relationship diagram coupled to the knowledge graph. The subgraph in FIG. 1 is used as an example. The graph data D1 can include a node and/or a connecting edge shown in FIG. 1, and specifically includes a node attribute and/or an edge attribute. The node attribute includes a node identifier (id), a node name, and other information. The edge attribute includes information such as an orientation of the node and an establishment time of the connecting edge. The ontology information of the subgraph in FIG. 1 can include node types of all nodes in FIG. 1 and relationship types of all connecting edges.

In step S220, several sentences are generated based on several pre-constructed sentence templates M, the graph data D1, and the ontology information B1. The several sentences are classified into a generated sentence set A.

“Several” means one or more. A sentence generated based on the graph data varies with sentence template M. Different sentence templates M can be used to extract different levels of knowledge in the subgraph, to obtain a corresponding sentence.

At least one of the several sentence templates M is constructed based on the ontology information. The ontology information herein can be the ontology information of the subgraph, or can be ontology information of the knowledge graph.

When this step is performed, based on a correspondence between a sentence component and each of graph data and ontology information included in the sentence template M, matching can be performed on the graph data D1 and the ontology information B1 that are obtained, to determine a sentence component corresponding to the graph data and/or the ontology information that are/is obtained, so as to generate a sentence.

In an implementation, a sentence can be generated based on the triplet in the graph data. For example, when any triplet in the several triplets includes a head node, a connecting edge, and a tail node, when several sentences are generated, several sentences corresponding to the any triplet can be generated based on the several pre-constructed sentence templates. When a sentence is generated based on the triplet, there can be a plurality of implementations.

The several sentence templates M can include a first-type template M1. The several generated sentences include a first sentence, and the first sentence is generated based on the first-type template M1. For the first sentence, a name of the head node is used as a subject, a relationship type corresponding to the connecting edge is used as a verb, and a name of the tail node is used as an object.

When the first sentence is generated, a name of a head node of a triplet in the graph data D1 can be used as a subject, a relationship type of the triplet is used as a verb, and a name of a tail node is used as an object.

In a specific implementation, the first-type template M1 can also be a template applied when the relationship type is a first-type relationship type. When the relationship type is a second-type relationship type, for the first sentence, a name of the tail node is used as a subject, a relationship type corresponding to the connecting edge is used as a verb, and a name of the head node is used as an object. The first-type relationship type and the second-type relationship type are completely different relationship types. In a head node and a tail node that are connected by the first-type relationship type, the head node plays a leading role, and the tail node plays a subordinate role. For example, in a triplet “A cat-prefers-cat food”, “cat” plays a leading role, and “cat food” plays a subordinate role. In a head node and a tail node that are connected by the second-type relationship type, the tail node plays a leading role, and the head node plays a subordinate role. In this implementation, in this case, the ontology information of the knowledge graph can be fully used, to generate a more logical text, and avoid an illogical text.

When a sentence is generated based on the first-type template M1, all or some triplets in the subgraph K1 can be matched with the first-type template M1, to generate a plurality of sentences. For example, a sentence in Table 1 can be generated based on the first-type template M1 and the subgraph in FIG. 1.

TABLE 1

| Subject - | Verb - | Object - | |
|---|---|---|---|
| name of a | relationship | name of a | Complete |
| head node | type | tail node | sentence |
| Store xx | Purchases | Cola | A store xx purchases |
| | | | cola |
| Store xx | Purchases | Soda water | A store xx purchases |
| | | | soda water |
| Store xx | Purchases | Orange juice | A store xx purchases |
| | | | orange juice |
| Store xx | Owns | Cat | A store xx owns a cat |
| Store xx | Purchases | Cat food | A store xx purchases |
| | | | cat food |
| Cat | Prefers | Cat food | A cat prefers cat food |
| Cola | Is | Beverage | Cola is a beverage |
| Soda water | Is | Beverage | Soda water is a beverage |
| Orange juice | Is | Beverage | Orange juice is a beverage |

The first three columns of the first row in Table 1 show the correspondence between a sentence component and each of graph data and ontology information in the sentence template. The name of the head node and the name of the tail node are graph data, and the relationship type is ontology information.

The several sentence templates M include a second-type template M2. The several generated sentences include a second sentence, and the second sentence is generated based on the second-type template M2. For the second sentence, a type of a head node is used as a subject, a relationship type corresponding to a connecting edge is used as a verb, and a type of a tail node is used as an object. When a sentence is generated based on the second-type template M2, all or some triplets in the subgraph K1 can be matched with the second-type template M2, to generate a plurality of sentences.

For example, a sentence in Table 2 can be generated based on the second-type template M2 and the subgraph in FIG. 1.

TABLE 2

| Subject - | Verb - | Object - | |
|---|---|---|---|
| type of a | relationship | type of a | Complete |
| head node | type | tail node | sentence |
| Merchant | Purchases | Product | A merchant purchases |
| | | | a product |
| Product | Belongs to | Category | A product belongs |
| | | | to a category |
| Merchant | Owns | Pet | A merchant owns a pet |
| Pet | Prefers | Product | A pet prefers a product |

The first three columns of the first row in Table 2 show a correspondence between ontology information in the sentence template and a sentence component. The type of the head node, the type of the tail node, and the relationship type are ontology information. Each triplet can generate a sentence based on the second-type template M2. Therefore, a repeated sentence is generated in this manner. Table 2 does not repeatedly show all sentences, but shows only one of repeated sentences.

When a sentence is generated, not only the triplet in the graph data can be used, but also node information in the graph data can be used, to generate a sentence including more node information.

For example, node information of a target node can be extracted from the graph data D1 and the ontology information B1, and several sentences corresponding to the target node are generated based on the several pre-constructed sentence templates M and the node information. Specifically, the node information can be matched with the sentence template M, to determine a component of the node information in a sentence, so as to generate the sentence.

The node information includes a node name and a node type. The target node can be any node in the subgraph K1, or can be a central node or another specified node in the subgraph K1.

The sentence template M can include a third-type template M3. The several sentences include a third sentence, and the third sentence is generated based on the third-type template M3. For the third sentence, the node type in the node information is used as a subject, a preset word representing an inclusive relationship is used as a verb, and the node name in the node information is used as an object. The preset word representing the inclusive relationship can include “include”, “contain”, etc. For example, a sentence in Table 3 can be generated based on the third-type template M3 and the subgraph in FIG. 1.

TABLE 3

| Subject - | Verb - | Object - | Complete |
|---|---|---|---|
| node type | includes | node name | sentence |
| Product | Includes | Cola | A product includes cola |
| Product | Includes | Soda water | A product includes soda water |
| Product | Includes | Orange juice | A product includes orange juice |
| Product | Includes | Cat food | A product includes cat food |
| Category | Includes | Beverage | A product includes beverage |
| Merchant | Includes | Store xx | A merchant includes a store xx |
| Pet | Includes | Cat | A pet includes a cat |

The first three columns of the first row in Table 3 show the correspondence between a sentence component, graph data and ontology information in the sentence template. The node name is graph data, and the node type is ontology information. Each node in the subgraph K1 can generate a sentence based on the third-type template M3, or some nodes can be selected from the subgraph K1, and generate a sentence based on the third-type template M3.

In an implementation, a sentence can be generated based on a logical reasoning rule. The logical reasoning rule can be extracted from the knowledge graph based on a rule extraction algorithm, or can be obtained by an expert based on experience. In a specific implementation, a sentence can be generated based on steps 1 to 3. Such a manner of generating a sentence can be referred to as generating a sentence based on a rule template.

Step 1: After the graph data D1 and the ontology information B1 of the subgraph K1 are read, several logical reasoning rules determined from the knowledge graph can be obtained.

Step 2: The graph data D1 and the ontology information B1 each are matched with the several logical reasoning rules, to obtain a matching rule.

Step 3: The graph data D1 is combined with the matching rule, to generate a corresponding sentence, where the corresponding sentence is classified into a generated sentence set A.

Any logical reasoning rule includes a logical condition and a reasoning result. The logical reasoning rule includes the ontology information of the knowledge graph. For example, a rule a is “A merchant purchases a product (for a plurality of times), and a product belongs to a category—A merchant prefers a category”. The arrow follows a logical condition and is followed by a reasoning result. In the rule a, “merchant”, “product”, and “category” are node types, and “purchases” and “belongs to” are relationship types, and are both ontology information.

In step 2, when the graph data D1 and the ontology information B1 each are matched with the several logical reasoning rules, the graph data D1 and the ontology information B1 each can be matched with logical conditions of the several logical reasoning rules. When step 3 is performed, the node information in the graph data D1 can be specifically combined with a reasoning result of the matching rule. The node information can include a node name and a node type.

During matching, all triplets in the subgraph K1 each can be matched with the several logical reasoning rules. For example, when a triplet 1 “A store xx-purchases-Cola” is matched with the rule a, whether a type of a head node in the triplet 1 is “merchant”, whether a relationship type is “purchases”, and whether a type of a tail node is “product” can be determined, and whether a type of a head node in a triplet 2 “Cola-is-a beverage” connected to the triplet 1 is “product”, whether a relationship type is “is”, and whether the beverage is a category continue to be determined. If results of the above-mentioned determining are all yes, it is determined that matching succeeds at one time. When the triplet in the subgraph successfully matches the logical condition for a plurality of times, the rule a is referred to as a matching rule.

After the graph data D1 and the ontology information B1 are matched with the several logical reasoning rules, one or more matching rules can be obtained. For each matching rule, a sentence corresponding to the matching rule can be obtained by combining the graph data D1 with the matching rule.

In step 3, the node information can be a node name, so that the node name in the graph data D1 can correspond to the reasoning result of the matching rule. The node name is substituted into the reasoning result, to obtain a generated sentence. In an example, for a process of combining the triplet with the matching rule, references can be made to Table 4.

TABLE 4

| Rule 1 | Logical condition: A merchant purchases | | Reasoning result: | Generated |
|---|---|---|---|---|
| | a product (for a plurality of times), | | A merchant prefers | sentence: |
| | and the product belongs to a category | | a category | A store xx |
| Triplet | A store xx- | Quantity of | Correspondence | prefers a |
| | purchases-cola, and | matching | between graph data | beverage |
| | cola-is-a beverage | times: 3 | and a reasoning | |
| Triplet | A store xx- | | result: | |
| | purchases-soda | | merchant = | |
| | water, and soda | | store xx, and | |
| | water-is-a beverage | | category = | |
| Triplet | A store xx- | | beverage | |
| | purchases-orange | | | |
| | juice, and orange | | | |
| | juice-is-a beverage | | | |

The first row shows the logical condition and the reasoning result of the rule 1, the second row to the fourth row show the triplets matching the rule 1 in the graph data and the quantity of matching times, and a node name in the graph data corresponds to a node type in the reasoning result, to obtain the generated sentence: A store xx prefers a beverage.

When the logical reasoning rule is obtained, a confidence of the logical reasoning rule can further be correspondingly obtained. For example, a confidence of the matching rule is a first confidence. When the corresponding sentence is generated, a first probability descriptor corresponding to the first confidence can be determined from a preset correspondence between a confidence and a probability descriptor, the graph data is combined with the matching rule, and the first probability descriptor is added to the generated sentence. The first probability descriptor can be added at a preset location. For example, the first probability descriptor is added between a verb and a subject.

The probability descriptor can include words such as “very”, “possible”, and “somewhat possible” that represent different confidences. This makes the generated sentence have a more accurate meaning and be close to a natural language.

In step S230, a text corpus corresponding to the subgraph K1 is determined based on the generated sentence set A. The text corpus is used to train a language model.

The generated sentence set A can include a plurality of sentences generated based on different sentence templates. For example, the generated sentence set A includes the sentences generated in Tables 1 to 4. To make the text corpus more refined, a plurality of sentences in the generated sentence set A can be deduplicated, the duplicate-free generated sentence set A is combined, and a sentence obtained through combination is used as the text corpus corresponding to the subgraph K1.

For example, when a sentence is generated based on the second-type template M2, a sentence is repeatedly generated, and references is made to the description in Table 2. In this case, repeated sentences need to be deduplicated.

When sentences are combined, sentences with the same subject and verb and sentences with the same verb and object can be selected from the generated sentence set A as to-be-combined sentences, and the to-be-combined sentences are combined.

The sentence with the same subject and verb can be combined into a multi-object sentence. A preset separator can be added between a plurality of objects. The sentences with the same verb and object can be combined into a multi-subject sentence, and a preset separator can be added between a plurality of subjects. The preset separator includes, for example, an enumeration comma or a comma. A connecting character such as “and” can further be added between the last two parallel subjects or parallel objects.

For example, in Table 1, an object combination and a subject combination can be performed on the complete sentence part, to obtain “A store xx purchases cola, soda water, orange juice, and cat food, and cola, soda water, and orange juice are beverages”.

In this embodiment provided in this specification, all sentence templates satisfy a syntax requirement, and have a subject-verb-object structure. A plurality of types of templates organize data into a training corpus from four logical perspectives. The first-type template M1 states a data fact in the subject-verb-object structure, the second-type template M2 is used to describe ontology knowledge, the third-type template M3 states a specific node name included in the node type, and the rule template describes a rule-based reasoning process. The four types of templates are four clear logical statements. In addition, the template combines the ontology information and the logical reasoning rule with fact data, and uses valuable ontology information and rule knowledge of the knowledge graph to the maximum extent, to generate a large quantity of training corpora that have strict logic and correct facts and satisfy syntax, and satisfy a requirement of the language model or even the large language model for a huge quantity of high-quality training corpora.

In this specification, “first” in words such as the first-type template, the first confidence, and the first probability descriptor and corresponding “second” (if present) in this specification are merely used for ease of distinguishing and description, and have no limitation meaning.

The above-mentioned content describes a specific embodiment of this specification, and another embodiment falls within the scope of the appended claims. In some cases, the actions or steps described in the claims can be performed in a sequence different from that in the embodiments and desired results can still be achieved. In addition, processes described in the accompanying drawings do not necessarily need a specific order or a sequential order shown to achieve the desired results. In some implementations, multitasking and parallel processing are possible or may be advantageous.

FIG. 3 is a schematic block diagram of an apparatus for generating a text corpus by using a knowledge graph according to an embodiment. Graph elements of the knowledge graph include a node representing an entity and a connecting edge representing a relationship between nodes. The apparatus 300 is deployed in a computing device. The computing device can be implemented by any apparatus, device, platform, device cluster, etc. having a computing and processing capability. This apparatus embodiment corresponds to the method embodiment shown in FIG. 2. The apparatus 300 includes:
a reading module 310, configured to read graph data and ontology information of a subgraph in the knowledge graph, where the graph data includes several triplets including graph elements in the subgraph, and the ontology information includes at least a type of each graph element in the subgraph;
a generation module 320, configured to generate several sentences based on several pre-constructed sentence templates, the graph data, and the ontology information, where the several sentences are classified into a generated sentence set, and at least one of the several sentence templates is constructed based on the ontology information; and
a determining module 330, configured to determine a text corpus corresponding to the subgraph based on the generated sentence set, where the text corpus is used to train a language model.

In an implementation, any triplet in the several triplets includes a head node, a connecting edge, and a tail node, and the generation module 320 is specifically configured to:
generate several sentences corresponding to the any triplet based on the several pre-constructed sentence templates.

In an implementation, the several sentence templates include a first-type template, the several sentences include a first sentence, and for the first sentence, a name of the head node is used as a subject, a relationship type corresponding to the connecting edge is used as a verb, and a name of the tail node is used as an object.

In an implementation, the several sentence templates include a second-type template, the several sentences include a second sentence, and for the second sentence, a type of the head node is used as a subject, a relationship type corresponding to the connecting edge is used as a verb, and a type of the tail node is used as an object.

In an implementation, the generation module 320 includes: an extraction submodule and a generation submodule (not shown in the figure).

The extraction submodule is configured to extract node information of a target node from the graph data and the ontology information. The node information includes a node name and a node type.

The generation submodule is configured to generate several sentences corresponding to the target node based on the several pre-constructed sentence templates and the node information.

In an implementation, the several sentence templates include a third-type template, the several sentences include a third sentence, and for the third sentence, the node type is used as a subject, a preset word representing an inclusive relationship is used as a verb, and the node name is used as an object.

In an implementation, the apparatus 300 further includes an obtaining module, a matching module, and a combination module (not shown in the figure).

The obtaining module is configured to obtain several logical reasoning rules determined from the knowledge graph. The logical reasoning rule includes the ontology information of the knowledge graph.

The matching module is configured to match the graph data and the ontology information with each of the several logical reasoning rules, to obtain a matching rule.

The combination module is configured to combine the graph data with the matching rule, to generate a corresponding sentence. The sentence is classified into the generated sentence set.

In an implementation, any logical reasoning rule includes a logical condition and a reasoning result;

The matching module is specifically configured to match the graph data and the ontology information with a logical condition of each of the several logical reasoning rules.

The combination module is specifically configured to combine node information in the graph data with a reasoning result of the matching rule.

In an implementation, a confidence of the matching rule is a first confidence; and the combination module includes a determining submodule and a combination submodule (not shown in the figure).

The determining submodule is configured to determine a first probability descriptor corresponding to the first confidence from a preset correspondence between a confidence and a probability descriptor.

The combination submodule is configured to: combine the graph data with the matching rule, and add the first probability descriptor to the generated sentence.

In an implementation, the determining module 330 is specifically configured to:
combining a plurality of sentences in the generated sentence set, and using a sentence obtained through combination as the text corpus corresponding to the subgraph.

In an implementation, when the determining module 330 combines the plurality of sentences in the generated sentence set, the following step is included:
deduplicating the plurality of sentences in the generated sentence set, and combining the duplicate-free generated sentence set.

In an implementation, when the determining module 330 combines the plurality of sentences in the generated sentence set, the following step is included:
selecting to-be-combined sentences from the generated sentence set, and combining the to-be-combined sentences, where the to-be-combined sentences include sentences with the same subject and verb and sentences with the same verb and object.

The apparatus embodiment corresponds to the method embodiment. For specific descriptions, references can be made to the descriptions in the method embodiment. Details are not described herein again. The apparatus embodiment is obtained based on the corresponding method embodiment, and have the same technical effects as the corresponding method embodiment. For specific descriptions, references can be made to the corresponding method embodiment.

An embodiment of this specification further provides a computer-readable storage medium. The computer-readable storage medium stores a computer program. When the computer program is executed in a computer, the computer is enabled to perform the method described in any one of FIG. 1 to FIG. 2.

An embodiment of this specification further provides a computing device, including a memory and a processor. The memory stores executable code, and when the processor executes the executable code, the method in any one of FIG. 1 to FIG. 2 is implemented.

The embodiments of this specification are described in a progressive way. For same or similar parts in the embodiments, references can be made to each other. Each embodiment focuses on a difference from another embodiment. In particular, the embodiments of the storage medium and the computing device are basically similar to the method embodiment, and therefore are described briefly. For related parts, references can be made to related descriptions in the method embodiment.

A person skilled in the art should be aware that in the one or more examples, functions described in embodiments of this application can be implemented by hardware, software, firmware, or any combination thereof. When implemented by software, these functions can be stored in a computer-readable medium or transmitted as one or more instructions or code on a computer-readable medium.

The above-mentioned specific implementations further describe in detail the objectives, technical solutions, and beneficial effects of the embodiments of this application. It should be understood that the previous descriptions are merely some specific implementations of the embodiments of this application and are not intended to limit the protection scope of this application. Any modification, equivalent replacement, or improvement made based on the technical solutions of this application shall fall within the protection scope of this application.

What is claimed is:

1. A method for generating a text corpus by using a knowledge graph, wherein graph elements of the knowledge graph comprise a node representing an entity and a connecting edge representing a relationship between nodes, and the method comprises:
reading graph data and ontology information of a subgraph in the knowledge graph, wherein the graph data comprises several triplets comprising graph elements in the subgraph, and the ontology information comprises at least a type of each graph element in the subgraph;
generating several sentences based on several pre-constructed sentence templates, the graph data, and the ontology information, wherein the several sentences are classified into a generated sentence set, and at least one of the several sentence templates is constructed based on the ontology information; and
determining a text corpus corresponding to the subgraph based on the generated sentence set, wherein the text corpus is used to train a language model.

2. The method according to claim 1, wherein any triplet in the several triplets comprises a head node, a connecting edge, and a tail node, and the step of generating several sentences comprises:
generating several sentences corresponding to the any triplet based on the several pre-constructed sentence templates.

3. The method according to claim 2, wherein the several sentence templates comprise a first-type template, the several sentences comprise a first sentence, and for the first sentence, a name of the head node is used as a subject, a relationship type corresponding to the connecting edge is used as a verb, and a name of the tail node is used as an object.

4. The method according to claim 2, wherein the several sentence templates comprise a second-type template, the several sentences comprise a second sentence, and for the second sentence, a type of the head node is used as a subject, a relationship type corresponding to the connecting edge is used as a verb, and a type of the tail node is used as an object.

5. The method according to claim 1, wherein the step of generating several sentences comprises:
extracting node information of a target node from the graph data and the ontology information, wherein the node information comprises a node name and a node type; and
generating several sentences corresponding to the target node based on the several pre-constructed sentence templates and the node information.

6. The method according to claim 5, wherein the several sentence templates comprise a third-type template, the several sentences comprise a third sentence, and for the third sentence, the node type is used as a subject, a preset word representing an inclusive relationship is used as a verb, and the node name is used as an object.

7. The method according to claim 1, further comprising:
obtaining several logical reasoning rules determined from the knowledge graph, wherein the logical reasoning rule comprises the ontology information of the knowledge graph;
matching the graph data and the ontology information with each of the several logical reasoning rules, to obtain a matching rule; and
combining the graph data with the matching rule, to generate a corresponding sentence, wherein the sentence is classified into the generated sentence set.

8. The method according to claim 7, wherein any logical reasoning rule comprises a logical condition and a reasoning result;
the step of matching the graph data and the ontology information with each of the several logical reasoning rules comprises:
matching the graph data and the ontology information with a logical condition of each of the several logical reasoning rules; and
the step of generating a corresponding sentence comprises:
combining node information in the graph data with a reasoning result of the matching rule.

9. The method according to claim 7, wherein a confidence of the matching rule is a first confidence; and
the step of generating a corresponding sentence comprises:
determining a first probability descriptor corresponding to the first confidence from a preset correspondence between a confidence and a probability descriptor; and
combining the graph data with the matching rule, and adding the first probability descriptor to the generated sentence.

10. The method according to claim 1, wherein the step of determining a text corpus corresponding to the subgraph comprises:
combining a plurality of sentences in the generated sentence set, and using a sentence obtained through combination as the text corpus corresponding to the subgraph.

11. The method according to claim 10, wherein the step of combining a plurality of sentences in the generated sentence set comprises:
deduplicating the plurality of sentences in the generated sentence set, and combining the duplicate-free generated sentence set.

12. The method according to claim 10, wherein the step of combining a plurality of sentences in the generated sentence set comprises:
selecting to-be-combined sentences from the generated sentence set, and combining the to-be-combined sentences, wherein the to-be-combined sentences comprise sentences with the same subject and verb and sentences with the same verb and object.

13. A non-transitory computer-readable storage medium, wherein the non-transitory computer-readable storage medium stores a computer program, which when executed by a processor causes the processor to:
read graph data and ontology information of a subgraph in the knowledge graph, wherein the graph data comprises several triplets comprising graph elements in the subgraph, and the ontology information comprises at least a type of each graph element in the subgraph;
generate several sentences based on several pre-constructed sentence templates, the graph data, and the ontology information, wherein the several sentences are classified into a generated sentence set, and at least one of the several sentence templates is constructed based on the ontology information; and
determine a text corpus corresponding to the subgraph based on the generated sentence set, wherein the text corpus is used to train a language model.

14. A computing device, comprising a memory and a processor, wherein the memory stores executable code, and when the processor executes the executable code, the computing device is caused to:
read graph data and ontology information of a subgraph in the knowledge graph, wherein the graph data comprises several triplets comprising graph elements in the subgraph, and the ontology information comprises at least a type of each graph element in the subgraph;
generate several sentences based on several pre-constructed sentence templates, the graph data, and the ontology information, wherein the several sentences are classified into a generated sentence set, and at least one of the several sentence templates is constructed based on the ontology information; and
determine a text corpus corresponding to the subgraph based on the generated sentence set, wherein the text corpus is used to train a language model.

15. The computing device according to claim 14, wherein any triplet in the several triplets comprises a head node, a connecting edge, and a tail node, and the step of generating several sentences comprises:
generating several sentences corresponding to the any triplet based on the several pre-constructed sentence templates.

16. The computing device according to claim 15, wherein the several sentence templates comprise a first-type template, the several sentences comprise a first sentence, and for the first sentence, a name of the head node is used as a subject, a relationship type corresponding to the connecting edge is used as a verb, and a name of the tail node is used as an object.

17. The computing device according to claim 15, wherein the several sentence templates comprise a second-type template, the several sentences comprise a second sentence, and for the second sentence, a type of the head node is used as a subject, a relationship type corresponding to the connecting edge is used as a verb, and a type of the tail node is used as an object.

18. The computing device according to claim 14, wherein the step of generating several sentences comprises:
extracting node information of a target node from the graph data and the ontology information, wherein the node information comprises a node name and a node type; and
generating several sentences corresponding to the target node based on the several pre-constructed sentence templates and the node information.

19. The computing device according to claim 18, wherein the several sentence templates comprise a third-type template, the several sentences comprise a third sentence, and for the third sentence, the node type is used as a subject, a preset word representing an inclusive relationship is used as a verb, and the node name is used as an object.

20. The computing device according to claim 14, wherein the computing device is further caused to:
obtain several logical reasoning rules determined from the knowledge graph, wherein the logical reasoning rule comprises the ontology information of the knowledge graph;
match the graph data and the ontology information with each of the several logical reasoning rules, to obtain a matching rule; and
combine the graph data with the matching rule, to generate a corresponding sentence, wherein the sentence is classified into the generated sentence set.
